(19) United States
(12) Patent Application Publication
(10) Pub. No.: US 2009/0048980 A1
(43) Pub. Date: Feb. 19, 2009

(54) Method for maximizing a negotiation result

(75) Inventor: Ronald Hubsher, New York, NY (US)

Correspondence Address: AMSTER, ROTHSTEIN & EBENSTEIN LLP, 90 PARK AVENUE, NEW YORK, NY, 10016, US

(73) Assignee: Sales Optimization Group

(21) Appl. No.: 11/891,888

(22) Filed: Aug. 14, 2007

(51) Int. Cl. G06Q 99/00; G06Q 10/00

(52) U.S. Cl. 705/80; 705/7

(57) ABSTRACT

The present invention generally relates to a system and method for maximizing a negotiation result in which certain conditions and criteria must be met before commencing negotiations. The present invention also provides a seller with evaluation tools to assess the buyer's needs and to determine whether the seller is in a strong position to negotiate a favorable deal once the conditions and criteria are met. In one embodiment, the evaluation tools include a method for calculating the impact of a price discount on the seller's commission. The method of the present invention can be implemented on computer software or through an Internet website.

### FIELD OF THE INVENTION

The present invention generally relates to a system and method for maximizing a negotiation result in which certain conditions and criteria must be met before commencing negotiations. The present invention also provides a seller with evaluation tools to assess the buyer's needs and to determine whether the seller is in a strong position to negotiate a favorable deal once the conditions and criteria are met.

### BACKGROUND OF THE INVENTION

There are few known analytical tools used in the sales force that assist sellers of goods and/or services in formulating a strategy to maximize a negotiation result. According to known methods, a seller of goods or services typically enters into a negotiation at the buyer's will, and the seller does not set criteria relating to his or her needs which must be met before entering into the negotiation. As a result, the seller does not typically negotiate from a position of maximal strength.

While the prior art methods are of interest, they do not seek to maximize a negotiation result. Thus, sellers of goods or services often do not achieve the best possible negotiated result.

### SUMMARY OF THE INVENTION

There is a long-felt need for a system and method for maximizing a negotiation result. The present invention seeks to solve this long-felt need and overcome the problems associated with the known methods and systems of the prior art.

In particular, it is an object of the present invention to provide a system and method which enables a seller to identify criteria that must be met prior to commencing negotiations.

It is another object of the system and method of the present invention to set forth other criteria which may be considered once negotiations commence.

It is another object of the present invention to provide software which implements the foregoing methods.

It is another object of the present invention to provide a method by which a seller of goods or services can, in the course of negotiations, determine the impact of a price discount on the seller's commission.

It is another object of the present invention to solve the shortcomings of the prior art. Other objects will become apparent from the foregoing description.

It has now been found that the above-related objects of the present invention are obtained in the form of a method for maximizing a negotiation result for a seller comprising the steps of: establishing seller-specific criteria which must be met before entering into a negotiation, wherein a the criteria establishes that the seller is in a position of negotiation strength; engaging in a negotiation with a buyer if the criteria are met; and completing the negotiation to arrive at a negotiated result.

In one embodiment, the criteria that must be met comprises one or more of the following: the seller has established itself as the buyer's first choice; the seller has spoken with a decision maker at the buyer; the decision maker is a champion for the seller; no other issues are present and/or the seller has proven to the buyer that he or she provides the least risky solution.

The method may also further comprise the step of evaluating whether the seller is in a position of strength before engaging in the negotiation. For example, the step of evaluating may comprise the step of identifying one or more of the following: whether there has been an agreed upon quantifiable payback/return of investment; the buyer's budget and decision making process; the buyer's business and personal needs; any obstacles that must be overcome; any inefficient processes used by the buyer; benefits in improving the inefficient processes; consequences if no action is taken; impact of the seller's solution on the buyer; the competitive advantages the buyer will obtain from the seller; a win/win relationship has been established; and/or any other compelling events.

The method may also further comprise the steps of: confirming the buyer's return of investment; identifying costs that will accrue to the buyer if he or she delays in completing the negotiation; providing at least one non-monetary tradeoff to the buyer; providing at least one monetary tradeoff to the buyer; resisting any overtures by the buyer to negotiate a sale price down; and identifying benefits that the buyer will receive by completing the negotiation. In connection with resisting the buyer's efforts to negotiate the price down, the seller may identify to the buyer competitive advantages that he or she will obtain by completing the negotiation, including, for example, one or more of the following: a solution to the buyer's problems; an increase in uptime for the buyer; the ability to keep valued workers with the buyer's company; growth in the buyer's sales; and/or the ability to meet the buyer's deadlines.

The method may further comprise the step of exploring budgeting issues with the buyer (either in advance or during negotiations), including, for example, one or more of the following steps: identifying additional budget sources that would enable to buyer to complete the negotiation; obtaining information about the buyer's budget making process; and/or identifying the buyer's budget.

The method of the present invention may also comprise the step of determining the impact of providing the buyer with a price discount on the seller's commission. This method may comprise one or more of following steps: calculating the number of additional hours that the seller will be required to work if the discount is provided; calculating how much harder the seller will be required to work if the discount is provided; calculating an amount of sales the seller will make if the discount is not provided; calculating an amount of sales the seller will lose if the discount is provided; and calculating a commission the seller will earn if no discount is provided.

In another embodiment of the present invention, a system for maximizing a negotiation result for a seller according to the above methods is provided. This system comprises: a server; memory for storing information entered by a user, wherein the information comprises at least seller specific criteria which must be met before entering into a negotiation with a buyer and the criteria establishes that the seller is in a position of negotiation strength; code for tracking whether the criteria has been met; and a report generator for outputting a summary of information entered by a user, the information comprising at least the criteria. The memory may further store other information about the seller and buyer, including the information discussed above in describing the method of the present invention.

In another embodiment of the present invention, a system for determining the impact of providing the buyer with a price discount on a seller's commission is provided. This system comprises code for one or more of the following: calculating the number of additional hours that the seller will be required to work if the discount is provided; calculating the amount of sales the seller will make if the discount is not provided; calculating the amount of sales the seller will lose if the discount is provided. This system also comprises a report generator for providing a summary report of one or more of the following: the additional hours calculation, the sales made without a discount calculation, and/or the lost sales calculation.

### BRIEF DESCRIPTION OF THE DRAWINGS

The above and related objects, features and advantages of the present invention will be more fully understood with reference to the following detailed description of the preferred, albeit illustrative, embodiments of the present invention when considered in conjunction with the accompanying figures, wherein:

FIG. 1 is a flowchart showing the steps performed in connection with the method of the present invention;

FIG. 2 shows a method for calculating the impact of discounting a sale price on a seller's commission;

FIG. 3 shows a method for calculating the impact of discounting on a company's revenues, net income and market capitalization; and

FIG. 4 illustrates an embodiment of the user interface for the software of the present invention.

### DETAILED DESCRIPTION OF THE PREFERRED EMBODIMENTS

The present invention is directed to a system and method for maximizing a negotiation result. Specifically, the method and system assist salespersons in determining an appropriate time to negotiate a sale and to negotiate effectively and optimally. This process involves several steps, including, the utilization of a decision tree which governs the conditions which must be met before commencing negotiations. As a second step, if these conditions are present, the seller should evaluate whether he or she has sufficient information about the buyer's needs and/or whether the seller is in a strong position to negotiate a favorable deal with the buyer. The various aspects of this method and system are described below.

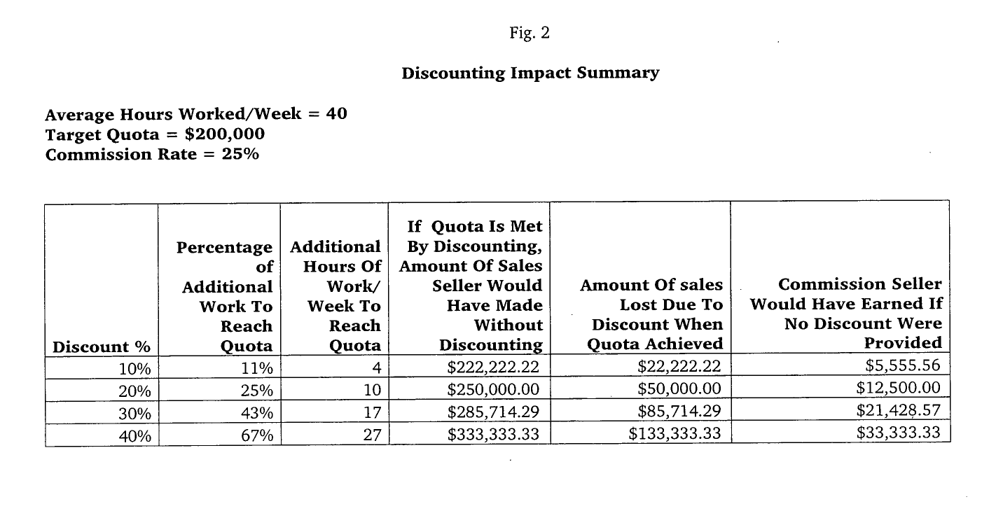

The system and method described herein can be performed across a variety of platforms, including, for example, a computer having data entry and processing software (e.g., Microsoft Excel®), an Internet website (e.g., via HTML forms and correlated databases for storing entered data), customized software having data entry and storage capability and/or conventional paper forms and recordkeeping methods. One skilled in the art would understand from the following description of the present invention how to implement the same in any of the above platforms. Indeed, as described below with respect to FIG. 2, in one embodiment, the present invention is implemented on a software platform.

According to the method of the present invention, the seller of goods or services establishes a list of criteria or conditions that must be present before commencing negotiations with a buyer. These criteria conditions can be unique to each seller. Thus, the seller should determine which criteria or conditions must be met before he or she will negotiate with a buyer, which in one embodiment, include one or more of the following: the seller has established himself or herself as the buyer's first choice; the seller has spoken with the decision maker at the buyer; a champion for the deal is a decision maker at the buyer; no other issues are present (e.g., there our no other obstacles that preclude finalizing a deal); and/or the seller has proven to the buyer that he or she provides the least risky solution. Other factors can be added to this list if desired.

By establishing conditions that must be met prior to negotiating with a buyer, the seller will be able to avoid entering into wasteful negotiations, including, for example, where the seller is not the buyer's first choice. Indeed, if the seller is not the buyer's first choice, the seller is less likely to consummate a deal. Similarly, by speaking to a decision maker, the seller will know whether he or she is the buyer's first choice. Likewise, if the decision maker at the buyer is a champion (e.g., supporter) for the seller, the buyer will be more likely to purchase the seller's goods or services. Similarly, by establishing that the seller is the least risky of all possible choices, it is more likely that the buyer will want to negotiate and consummate a result with the seller.

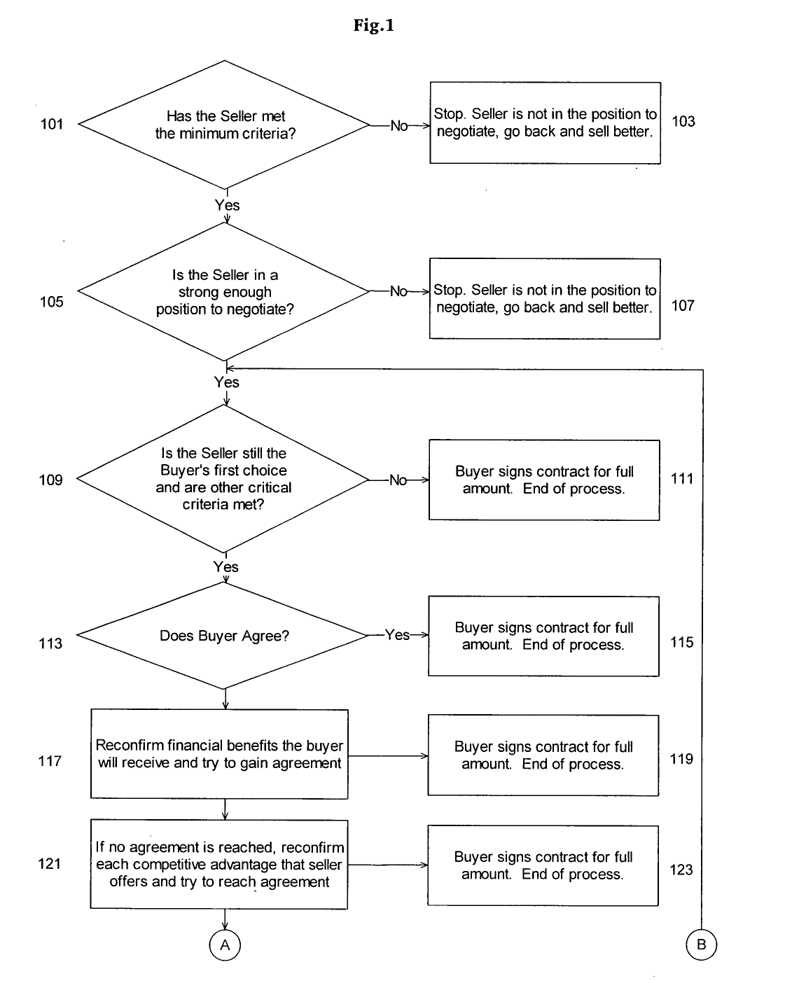

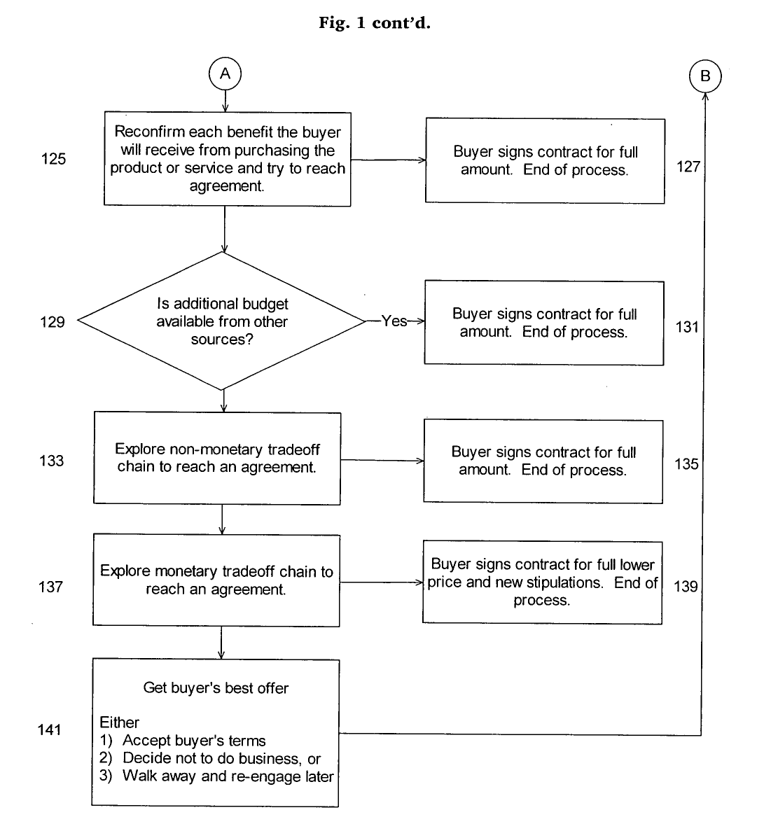

Thus, as shown in FIG. 1, before entering into a negotiation, one or more of the foregoing conditions/criteria must be met, step 101. If these conditions or criteria are not met, step 103, then the seller should stop the negotiation process since he or she is not yet in a position to negotiate. In such a case, the seller should reevaluate his or her sales process, and formulate a better sales method so that the foregoing conditions or criteria can be met.

If, on the other hand, the conditions required to negotiate are met, the seller should seek to consummate a sale as quickly as possible, and may engage in one or more of the following steps. Specifically, the seller should determine whether he or she is in a position of strength to negotiate effectively with the buyer, step 105. In this connection, the seller should have sufficient information about the buyer before negotiating, including, for example, one or more of the following: whether there has been an agreed upon quantifiable payback/return of investment; information about the budget and decision making process for the buyer; the business and personal needs of the buyer; any obstacles that must be overcome before entering into sale; any inefficient processes used by the buyers; the benefits in improving the inefficient processes; the consequences the buyer will suffer if no action is taken; the impact of the seller's solution on the buyer; whether the buyer knows the competitive advantages it will obtain from the seller; whether a win/win relationship has been established (e.g., both the seller and buyer obtain value from the deal); and/or any the compelling events.

If the seller is not in a position of strength to negotiate a favorable deal with the buyer (e.g., the seller does not have enough information about the buyer's needs), the seller may stop negotiating and restart the process with the goal of selling better, step 107.

If, on the other hand, the seller has sufficient information about the buyer and is in a position of strength to negotiate, then the seller should reconfirm that he or she is the buyer's first choice, step 109. If the seller is no longer the buyer's first choice, then the seller should stop negotiating with the buyer, step 111. If the seller is still the buyer's first choice, the seller could also confirm other important information, including, for example, the buyer's reasons for selecting the seller. Upon the buyer providing this information, the seller should seek to finalize the sale with the buyer, step 113. For example, the seller could state as follows to the buyer: “So that you can enjoy the benefits of our solution as quickly as possible, I would like get your approval to the proposal so we can cue up our implementation team immediately. Please let me know your thoughts.”

If, the buyer agrees to the proposal (step 115), then the buyer should agree to pay the full amount of the proposal. If the buyer is not ready to agree to the proposal (but appears willing to do so), then the seller should reconfirm the financial benefit the buyer will receive as an incentive to reach an agreement, step 117. The seller could also explain the costs that will accrue to the buyer if it delays in entering the deal. For example, if the seller's service will save the buyer $2,000 per week, then the seller could explain that by agreeing to a contract at that point in time, the buyer would immediately begin to save money. The seller could further explain that each day of delay has a cost of $400/day. If, after these benefits are explained, the seller agrees to the seller's proposal, the sale should be consummated and the process ends, step 119.

If, on the other hand, the buyer seeks to negotiate a lower price or is otherwise not ready to agree to the proposal, then the seller should resist the buyer's overtures to negotiate the price down and remind the buyer of the competitive advantages that the seller's services or product provides, and try to reach an agreement after each advantage is confirmed with the buyer, step 121. In this regard, the seller could refocus on the value the buyer will receive by agreeing to the seller's proposal. In this connection, the seller could emphasize the benefits that the buyer will receive from the seller's from goods or service, including any benefits that are unique to the goods or services being provided by the seller. For example, a seller of computer software may provide unlimited on-site training, whereas other sellers of software do not. This unique benefit could result in a 10% increase in the buyer's productivity, and thus, should be emphasized to the buyer.

An example of confirming competitive advantages with the buyer is shown in Table 1 below, wherein the seller confirms the competitive advantages the buyer will obtain from the seller, the level of importance of each advantage, the reasons that each advantage is important to the buyer and the value of each advantage to the buyer.

TABLE 1

| | How | | |
|---|---|---|---|
| | Important | Why is the | |
| Competitive | is the | Advantage | Value of the |
| Advantage | Advantage? | Important? | Advantage |
| On time delivery | Critical | If the delivery is | $13,500 per hour |
| | | late, the buyer's | of delay or hour |
| | | production | of delay saved |
| | | schedule goes Out | |
| | | of alignment. This | |
| | | costs the buyer | |
| | | lost productivity | |
| | | and machine | |
| | | downtime. | |
| Precision Fit | 10 out of 10 | If the part is | $1,600 per part |
| | | milled too small, | that is too small |
| | | buyer will have to | and $1,400 per |
| | | modify the part. | part that is too |
| | | If the part is too | large. |
| | | large, buyer will | |
| | | have to mill it | |
| | | down. | |

Referring to Table 1, one example of a competitive advantage that could be provided by the seller to the buyer is the on-time delivery of goods and services. In this example, this advantage is of “Critical” importance to the buyer since, if delivery is late, the buyer's production schedule will fall behind. As a result, the buyer will incur costs associated with lost productivity and machine downtime. In this example, on-time delivery would prevent the buyer from losing $13,500 per hour of delay. The precision fit of parts supplied by the seller is another example of a competitive advantage to the buyer. Here again, this is a top priority to the buyer (i.e., a “10 out of 10”). Indeed, if a part is too small or large, the buyer will have to modify the part to the correct size. The cost to correct the size of each part would be $1,600 or $1,400 in this example. Thus, the seller should confirm these competitive advantages to the buyer.

In step 121, the seller can ask the buyer to explain the reasons why the competitive advantage is important, as well as the value of having this advantage. After explaining these items of information, the seller should ask for the buyer's approval to the proposal so that the buyer can start enjoying the unique benefits offered by the seller. In this way, the seller can resist the buyer's overtures to negotiate the sales price down by having the buyer acknowledge the benefits it would be receiving from the seller. If, after engaging in step 121, the buyer is ready to agree to the proposal for the full amount, then the process ends, step 123.

If, on the other hand, the buyer continues to seek a lower price from the seller, or simply is not yet ready to agree, the seller should further confirm other benefits the buyer will obtain from the seller, step 125. These benefits can satisfy both the business and personal needs of the buyer, and overcome barriers to those needs. For example, the seller can explain that his or her goods or services will solve the buyer's computer problems and the buyer will be able to leave the office at the same time every day.

Additionally, the seller could have the buyer identify any of his or her currently used inefficient processes, and explain how the seller's goods or services could improve such processes. For example, the seller could explain to the buyer that he or she will have more “uptime”, if the buyer agrees to purchase the seller's goods or services. The seller should also emphasize the consequences of taking no action, including for example, that the buyer will lose competent and valued workers to competitors. Furthermore, the seller can explain the impact of his or her solution on these problems, including for example, that the buyer will be able to grow his or her sales. Finally, the seller could have the buyer identify compelling events, such as the need to meet legal requirements by a certain deadline and ensure the buyer that such events would occur if the buyer agrees to the seller's proposal. If, after engaging in step 125, the buyer is willing to agree to the proposal for the full selling price, then the sales process ends, step 127.

If, on the other hand, the buyer still is seeking to negotiate the price down, or is not ready to agree to the proposal, then the seller should explore (either in advance or during negotiations) budgeting issues with the buyer, step 129. In this connection, the seller should ask the buyer to assess whether there are additional budget sources that would enable the buyer to agree to the proposal. The seller should also seek information about the buyer's budget making processing, including how and when budgets are made, the amount of the budget and other sources from which the budget can be supplemented. For example, where the seller and buyer are $4,000 apart for a 50 person company, the seller can explain that this difference amounts to $80 per year per person in the company. Since there are 250 work days in the year, the cost per employee is $0.32 per day. The seller should then ask the buyer to find additional budget for $0.32 per day per employee. By breaking down the price differences in this way, the buyer may be more amenable to meeting the seller's price. If the buyer can get more budget, the seller should have the buyer agree to the proposal for the full amount, and the sales process ends, step 131.

If the buyer cannot get additional budget, then the seller can offer the buyer non-monetary tradeoffs, step 133. For example, instead of lowering the sales price, the seller can offer goods and/or services in exchange for the buyer's agreement to the proposal, and may even require the buyer to likewise provide non-monetary benefits to the seller.

For example, as shown in Table 2A below, the seller should identify non-monetary tradeoffs that he or she is willing to provided to the buyer, and identify the value of such tradeoffs to the buyer and the cost of the tradeoff to the seller. In the example shown in Table 2A, the seller is willing to provide a free week of training, unlimited technical support and on-site training to the buyer. Here, the seller has assigned values of these services to the buyer as well as costs to the seller.

TABLE 2A

| Non-Monetary Tradeoff | | |
|---|---|---|
| Provided By Seller | Value to Buyer | Cost to Seller |
| Free week of training | High | Low |
| Unlimited technical support | High | Med |
| Onsite training | Medium | High |

As shown in Table 2B below, the buyer identifies tradeoffs that he or she is willing to provide to the seller and the value of such tradeoffs to the seller. The tradeoff provided by the buyer in Table 2B is the provision of five referrals to the seller and a commitment to a longer term contract.

TABLE 2B

| Non-Monetary Tradeoff | | |
|---|---|---|
| Provided By Buyer | Value to Seller | Cost to Buyer |
| Agree today | High | None |
| 5 referrals | High | Low |
| Longer term contract | Medium | High |

Finally, the seller should consider different combinations of tradeoff chains to complete negotiations. For example, as shown in Table 2C below, the seller can identify the benefits that the buyer will receive as part of the tradeoff, the goods and services that will be provided by the seller and the tradeoffs that will be provided by the buyer. Preferably, as the benefits to the buyer increase, so do the tradeoffs.

TABLE 2C

| Benefit to Buyer | Seller To Provide | Buyer To Provide |
|---|---|---|
| Lower the risk of the | Free week of training | Sign today and provide |
| project | | seller with 5 referrals |
| Lower the risk of the | Free week of training | Sign today, provide seller |
| project and increase | and unlimited | with 10 referrals |
| user satisfaction | technical support | |
| Lower the risk of the | Free week of training, | Sign today, provide seller |
| project, increase user | unlimited technical | with 10 referrals and sign |
| satisfaction, and lower | support and | a 2 year commitment |
| the cost of training | on site training | |

Referring to Table 2C, where the sole benefit to the buyer is lowering the risk of a project, the seller provides a free week of training and the buyer, in exchange, agrees to the proposal that day and provides the seller with five referrals. Where the benefit to the buyer further includes an increase of user satisfaction, a free week of training and unlimited technical support is provided by the seller; in return, the buyer agrees to the proposal and provides the seller with ten referrals. Finally, where the seller provides the two benefits discussed above and also lowers the cost of training, the seller will provide the most tradeoffs to the buyer (e.g., a free week of training, unlimited technical support and onsite training) in exchange for receiving the tradeoffs identified in Table 2C.

If the buyer agrees to one of the offers from a non-monetary tradeoff chain, then the sale should be completed for the full amount and the agreed-to tradeoffs, step 135. In this case, the sales process ends.

If, on the other hand, no agreement is reached, then the seller should consider a monetary based tradeoff chain to offer to the buyer, step 137. In this connection, the seller can consider providing a price discount, and if it prefers to do so, combine such discount with the non-monetary tradeoffs discussed with reference to Tables 2A-2C. Table 3 below provides different examples of a monetary tradeoff chain according to one embodiment of the present invention.

TABLE 3

| Monetary Tradeoff | Non-monetary Tradeoff |
|---|---|
| Provided By Seller | Provided By Buyer |
| 5% discount | Sign today, provide seller 5 referrals |
| 5% discount and | Sign today, provide seller 10 referrals |
| Free week of training | |
| 10% discount | Sign today, provide seller 10 referrals |
| | and sign a 2 year commitment |
| More than 10% - walk away | Walk away |

However, before agreeing to a monetary tradeoff, the seller should consider the impact of providing the buyer with a discounted price on its take-home sales commission. In this connection, whenever a seller provides a discount to a buyer, the seller's commission will decrease. Thus, the seller will need to make additional sales to reach a target quota for commission. Moreover, by providing a discount, the seller will not realize the maximum commission that he or she would have earned if no discount is provided. As such, the present invention provides for a method of calculating the effect of the price discount on the additional hours that the seller will need to reach a sales commission quota, and the amount of commission that will be lost by providing such a discount.

More particularly, before providing a cash tradeoff, the seller should calculate the impact of a price discount on the additional number of work hours that will be required to recoup the commission that would be lost to the discount. For example, referring to FIG. 2, where a seller works an average of 40 hours per week, has a target quota of $200,000 in sales and earns a 25% commission rate on sales, the impact of various discounts on the seller's workload and commission is calculated. Referring to Table 2, for each discount percentage in column 1, the seller has calculated how much harder he or she will need to work to reach the target quota of $200,000, both by percentage and in actual hours (see Cols. 2 and 3, respectively). Additionally, where the seller has obtained the quota through discounting, the seller calculates the amount of sales that he or she would have obtained if no discount were provided (see Col. 4). Comparably, the seller calculates the amount of sales that were lost as a result of the discount (Col. 5). Finally, the seller calculates the commission that he or she would have earned if no discount is provided (Col. 6). The seller can then use this information in assessing whether or not to provide a monetary tradeoff.

For example, where the seller has provided a 10% discount, he or she can calculate, as a percentage, how much additional work will be required to reach the sales quota of $200,000. This calculation is made according to the following formula: Increase in work =(1/(1−discount rate))−1. Thus, where a 10% discount has been provided, the user will need to work 11% harder (i.e., 1/1.1))−1. Similarly, the number of additional work hours per week that will be required to reach the sales quota is calculated as follows: Additional Work Hours=(discount rate)×(average hours per week). Thus, in the above example, where a 10% discount is provided, the user will need to work 4 additional hours per week to achieve the target sales quota of $200,000 (i.e., 0.10×40 hours).

In the above example, the seller can also calculate the amount of sales that he or she would make if no discount is provided, as compared to the amount of sales where a discount is provided to reach the sales quota as follows: Sales Without Discount=(target quota)/(1−discount). Thus, where the seller provides a 10% discount to achieve a sales quota of $200,000, the seller would have sold $222,220 if no discount were provided (i.e., $200,000/1−0.1). Likewise, the seller can calculate the amount of sales that will be lost due to a discount as follows: Sales Lost=(sales that the seller would have earned but for the discount)−(the target sales quota). Thus, in the above example, the seller will loose $22,222.22 where a 10% discount is provided (i.e., $222,222.22−$200,000).

Finally, the seller can calculate the additional sales commission he or she would earn if no discount is provided according to the following formula: Lost Commissions=(sales lost due to discount)×(commission rate). Thus, in the example shown in FIG. 2, where the seller provides a 10% discount, the seller will lose $5,555.55 (i.e., $22,222.22*0.25). Similar calculations are provided in FIG. 2 with respect to a 20%, 30% and 40% discounts.

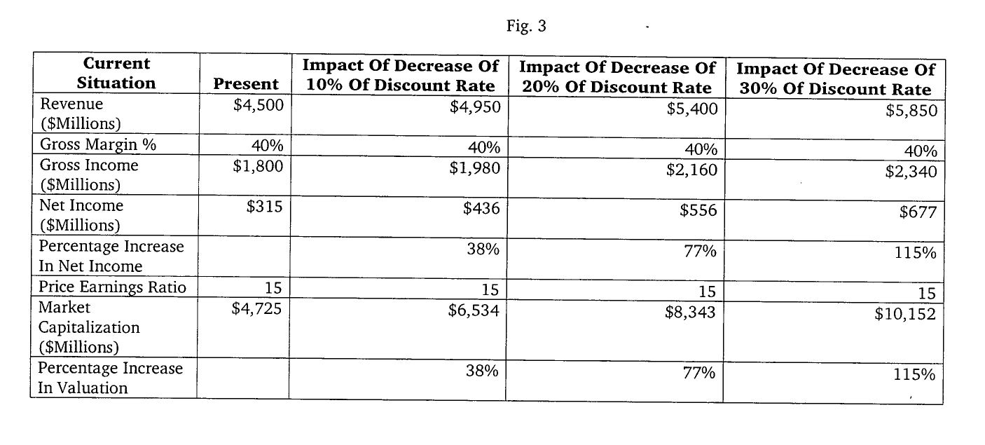

Additionally, before agreeing to a monetary tradeoff, the seller may consider the impact of providing the buyer with a discounted price on his or her company's revenues, net income and market capitalization. This method is described with reference to FIG. 3. In this regard, where the seller offers a standard discount rate (e.g., 40% discount), the seller can calculate the effect that a reduction in such discount rate will have on his or her company's bottom line.

More particularly, referring to FIG. 3, the seller can calculate the impact of a decrease in the discount rate on the revenues of his or her company according to the following formula: Increase in Revenues=current revenues×(1+decrease in discount). Where the seller decreases his or her discount by 10% and the seller's company current revenues are $4,500,000,000, the company's revenues will increase to 4,950,000,000 (i.e., $4,500,000,000×(1+0.1)). Similar calculations are made in FIG. 3 where the discount has been decreased by 20% and 30%.

Similarly, the seller can calculate the impact of reducing a discount on his or her company's gross income according to the following formula: Increase in Gross Income=Revenues×Gross Margin % of products sold by company. Thus, where the discount provided by the seller decreases by 10%, the seller's company increase in revenues due to the discount is 4,950,000,000 and the company's gross margin percent of products 40%, the company's gross income will increase to $1,980,000,000 (i.e., 4,950,000,000×0.40). Similar calculations are made in FIG. 3 where the discount has been decreased by 20% and 30%.

Furthermore, the seller can calculate the impact of reducing a discount on his or her company's net income according to the following formula: Increase in Net Income=Current Net Income+((Increase In Revenues due to discount−Current Revenues)×Gross Margin Percent)×(1−the company's tax rate)). Thus, if the discount provided by the seller decreases by 10%, the seller is taxed at a rate of 33% and has a current net income is $315,0000,000 and current revenues of $4,500,000,000 (and thus an increase in revenues to $4,950,000,000 due to the discount), the seller's net income will increase to $436,000,000 (i.e., $315,0000,000+(($4,950,000,000−$4,500,000,000)×0.4)×(1−0.33)). Similar calculations are made in FIG. 3 where the discount has been decreased by 20% and 30%.

Additionally, the impact of decreasing a discount on the percentage increase in the company's net income can be calculated according to the following formula: Increase in Percentage of Net Income=(Increase in Net Income/Current Net Income)−1. Thus, where the seller's company's Net Income has increased $315,0000,000 to $436,0000,000 due to a 10% decrease of the seller's discount rate, the seller will have a 38% increase in net income (i.e., ($436,0000,000/($315,0000,000)−1. Similar calculations are made in FIG. 3 where the discount has been decreased by 20% and 30%.

The seller can also calculate the impact of decreasing the discount rate on his or her company's Market Capitalization according to the following formula: Increase in Market Capitalization=Price Earnings Ratio×Increase In Net Income (due to decrease in discount). There, where the seller's company has a price earnings ratio of 15 and increase in Net Income to $436,000,000 due to a decrease of 10% in the seller's discount, the company's market capitalization increases from $4,725,000,000 to $6,534,000,00 (i.e., 15×$436,000,000). Similar calculations are made in FIG. 3 where the discount has been decreased by 20% and 30%.

Similarly, the percentage increase in the valuation of the seller's company due to a decrease in the seller's discount rate can be calculated as follows: Percentage Increase in Valuation=(Increase in Market Capitalization due to decrease in discount/current Market Capitalization)−1. Thus, where the seller's company has a current market capitalization of $4,725,000,000 which would increase to $6,534,000,00 if the seller's discount rate is decreased by 10%, then the increase in the company's valuation would be 38% (i.e., ($6,534,000,00/$4,725,000,000)−1). Similar calculations are made in FIG. 3 where the discount has been decreased by 20% and 30%.

Thus, by decreasing a discount provided by the seller, the seller will experience an increase in the earnings before taxes, interest and depreciation, an increase in close rates, a reduction in discounting and an increase in sales velocity.

If the seller, even after undertaking one or more of the foregoing calculations, decides to provide a dollar based tradeoff (e.g., a discount), then the seller should seek to finalize the sale with the buyer and close the sales process, step 139. If on the other hand, either the seller refuses to provide a discount, or the buyer is unwilling to enter into an agreement, the seller can rescind his or her sales proposal, reengage with the buyer at a later date or accept the buyer's terms, step 141. It should be noted that steps 109-141 are optional. Moreover, steps 117-141 can be performed in a different order if desired.

It should be understood that the criteria that must be met in steps 101-103 and the criteria that may be met in steps 105-141 are unique to each seller. Thus, if desired, any of the criteria set forth in steps 105-141 can be criteria which must be must in steps 101-103. Likewise, the criteria set forth in steps 101-103 can be criteria which may be met according to steps 105-141.

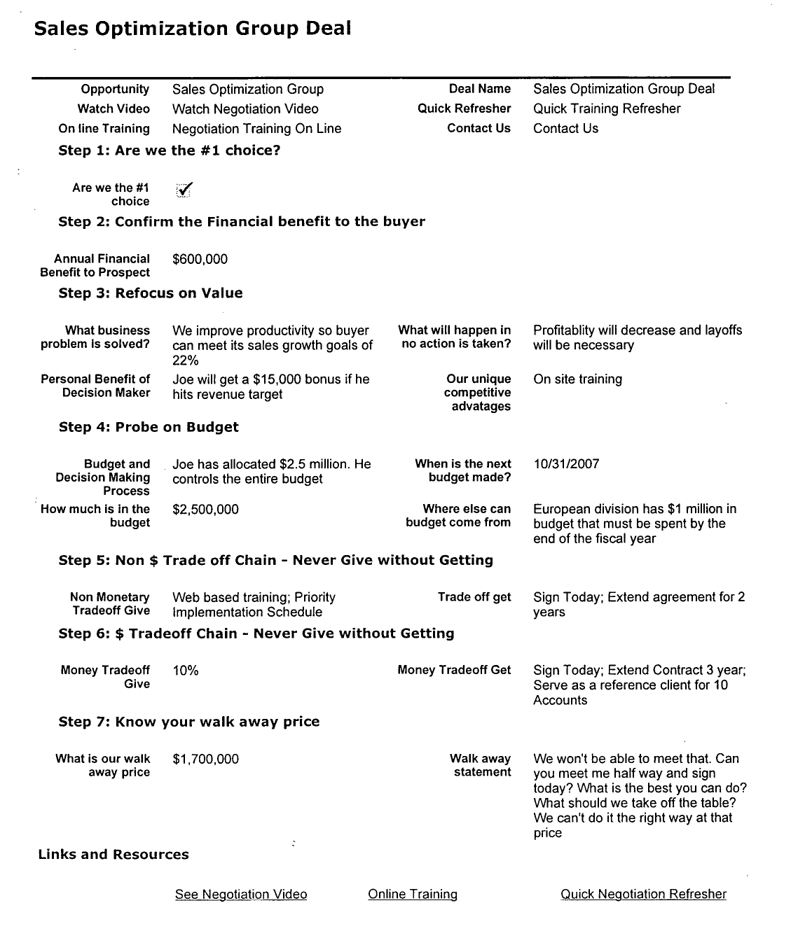

The foregoing methods can be implemented through the use of a software application, which in one embodiment, resides on an Internet website, as shown in FIG. 4. The software enables and assists a sales person in tracking and assuring that each of the foregoing steps are met. In this connection, the user can create a new “deal” by entering information into HTML-based form fields. As a preliminary step, the user identifies a particular “opportunity” (e.g., potential sale) and assigns a “deal name” to the opportunity. Optionally, online videos showing enactments of negotiations conducted according to the method of the present invention are provided to the user. Similarly, online training with respect to the foregoing method is provided. The training can be provided as a video course or as a written document describing each step of the process.

Referring to FIG. 4, the user is first prompted to confirm whether he or she is the buyer's “#1 choice.” A radio box is provided in which the seller confirms, by entering a check mark, that he or she is the buyer's #1, step 1. Next, the software prompts the seller to confirm the financial benefit to the prospect (e.g., the buyer). In this example, the seller has identified a $600.00 benefit to the buyer for its goods and services, step 2.

Next, the user is prompted to “refocus on value” of its goods and services, step 3. In this connection, the user is prompted to identify the business problems to be solved by his or her goods or services, what will happen if no action is taken, personal benefits of the goods or services to the decision maker at the buyer and a unique competitive advantage which is provided by the seller's goods or services. Here, HTML form fields are provided in which the user can enter this information in text boxes. Upon pressing a submit button, this information is saved to the website's server.

The seller is then prompted to “probe on budget,” step 4. In this step, a series of HTML form fields are provided in which the seller is prompted to enter information relating to the buyer's budget and decision making process, the date on which the budget is made, the amount of the budget and other potential sources for budget. Once the user enters any or all of this information and selects the submit button, this information will be saved to the server.

In step 5, the seller is prompted to identify non-monetary tradeoffs that he or she is willing to provide to the buyer as well as non-monetary tradeoffs that he or she is willing to receive. Here again, a series of HTML form fields are provided in which the user is prompted to enter information relating to acceptable non-monetary tradeoffs, step 5. Upon selecting the submit button, this information is saved to the server. In step 6, the seller is prompted to enter a monetary tradeoff chain that he or she is willing to provide (e.g., a discount) as well as a monetary tradeoff he or she is willing to receive from the buyer. Here again, by selecting the submit button, this information is saved to the server.

Finally, in step 7, the user is prompted to determine a “walk away price”—that is, the bottom line price at which the seller is willing to make a sale. The seller is also prompted to enter a “walk away statement”—that is, a prepared response should the buyer make an offer below the walk away price. According to the method and software of the present invention, only step 1 is required and steps 2-7 are all optional. However, by completing all of the form fields prior to engaging in negotiations with a buyer, the seller will be better prepared to negotiate from a position of strength.

Moreover, the method of calculating the impact of a discount on a seller's take home commission and on the seller's company's bottom line can be implemented through software, including, for example, the use of formulas on a spreadsheet application, such as Microsoft Excel.

Now that the preferred embodiments of the present invention have been shown and described in detail, various modifications and improvements thereon will become readily apparent to those skilled in the art. Accordingly, the spirit and scope of the present invention is to be construed broadly and limited only to the appended claims.

What is claimed is:

1. A method for maximizing a negotiation result for a seller comprising the steps of:
establishing seller-specific criteria which must be met before entering into a negotiation, wherein a said criteria establishes that the seller is in a position of negotiation strength;
engaging in a negotiation with a buyer if said criteria are met; and
completing said negotiation to arrive at a negotiated result.

2. The method of claim 1, where said criteria comprises one or more of the following: the seller has established itself as the buyer's first choice; the seller has spoken with a decision maker at the buyer; the decision maker is a champion for the seller; no other issues are present and/or the seller has proven to the buyer that he or she provides the least risky solution.

3. The method of claim 1, further comprising the step of evaluating whether the seller is in a position of strength before engaging in said negotiation.

4. The method of claim 3, wherein the step of evaluating comprises the step of identifying one or more of the following: whether there has been an agreed upon quantifiable payback/return of investment; the buyer's budget and decision making process; the buyer's business and personal needs; any obstacles that must be overcome; any inefficient processes used by the buyer; benefits in improving the inefficient processes; consequences if no action is taken; impact of the seller's solution on the buyer; the competitive advantages the buyer will obtain from the seller; a win/win relationship has been established; and/or any other compelling events.

5. The method of claim 1, further comprising the step of confirming the buyer's return of investment.

6. The method of claim 1, further comprising the step of identifying costs that will accrue to the buyer if he or she delays in completing said negotiation.

7. The method of claim 1, further comprising the step of resisting any overtures by the buyer to negotiate a sale price down.

8. The method of claim 7, wherein said step of resisting further comprises identifying to the buyer competitive advantages that he or she will obtain by completing said negotiation.

9. The method of claim 1, further comprising the step of identifying benefits that the buyer will receive by completing said negotiation.

10. The method of claim 9, wherein said benefits comprise one or more of the following: a solution to the buyer's problems; an increase in uptime for the buyer; the ability to keep valued workers with the buyer's company; growth in the buyer's sales; and/or the ability to meet the buyer's deadlines.

11. The method of claim 1, further comprising the step of exploring budgeting issues with the buyer.

12. The method of claim 11, wherein said exploring step further comprises one or more of the following steps: identifying additional budget sources that would enable to buyer to complete said negotiation; obtaining information about the buyer's budget making process; and/or identifying the buyer's budget.

13. The method of claim 1, further comprising the step of providing at least one non-monetary tradeoff to the buyer.

14. The method of claim 1, further comprising the step of providing at least one monetary tradeoff to the buyer.

15. The method of claim 14, further comprising the step of determining the impact of providing the buyer with a price discount on the seller's commission.

16. The method of claim 15, wherein said determining step comprises one or more of following steps:
calculating the number of additional hours that the seller will be required to work if said discount is provided;
calculating how much harder the seller will be required to work if said discount is provided;
calculating an amount of sales the seller will make if said discount is not provided;
calculating an amount of sales the seller will lose if said discount is provided; and
calculating a commission the seller will earn if no discount is provided.

17. The method of claim 14, further comprising the step of determining the impact of reducing a discount rate provided by the seller on the seller's company.

18. The method of claim 17, wherein said determining step comprises one or more of the following:
calculating the impact of reducing the discount rate on the company's revues;
calculating the impact of reducing the discount rate on the company's gross income;
calculating the impact of reducing the discount rate on the company's net income;
calculating the impact of reducing the discount rate on the company's market capitalization; and/or
calculating the impact of reducing the discount rate on the company's valuation.

19. A system for maximizing a negotiation result for a seller comprising:
a server;
memory for storing information entered by a user, wherein said information comprises at least seller specific criteria which must be met before entering into a negotiation with a buyer and said criteria establishes that the seller is in a position of negotiation strength;
code for tracking whether said criteria has been met; and
a report generator for outputting a summary of information entered by a user, said information comprising at least said criteria.

20. The system of claim 17, where said criteria comprises one or more of the following: the seller has established itself as the buyer's first choice; the seller has spoken with a decision maker at the buyer, the decision maker is a champion for the seller; no other issues are present and/or the seller has proven to the buyer that he or she provides the least risky solution.

21. The system of claim 17, wherein said memory also stores information indicating whether the seller is in a position of strength before engaging in said negotiation.

22. The system of claim 19, wherein said position of strength information comprises one or more of the following: whether there has been an agreed upon quantifiable payback/return of investment; the buyer's budget and decision making process; the buyer's business and personal needs; any obstacles that must be overcome; any inefficient processes used by the buyer; benefits in improving the inefficient processes; consequences if no action is taken; impact of the seller's solution on the buyer; the competitive advantages the buyer will obtain from the seller; a win/win relationship has been established; and/or any other compelling events.

23. The system of claim 17, wherein said memory stores competitive advantages that a buyer will obtain by completing said negotiation.

24. The system of claim 17, wherein said memory stores financial benefits that a buyer will receive by completing said negotiation.

25. The system of claim 17, wherein said memory stores information pertaining to a buyer's budget.

26. The system of claim 23, wherein said information pertaining to a buyer's budget comprises one or more of the following: additional budget sources that would enable the buyer to complete said negotiation; information about the buyer's budget making process; when the budget is made; and/or the buyer's budget.

27. The system of claim 1, wherein said memory stores at least one non-monetary tradeoff that may be provided to the buyer.

28. The system of claim 1, wherein said memory stores at least one monetary tradeoff that may be provided to the buyer.

29. The system of claim 1, wherein said memory stores a minimum price that a seller is willing to agree to.

30. A method for maximizing a negotiation result for a seller comprising the steps of:
engaging in a negotiation for a sale of goods or services with a buyer;
resisting overtures by the buyer to negotiate the sale price down, wherein said step of resisting comprises offer at least one non-monetary trade-off to the buyer in lieu of a price discount; and
and completing said negotiation to arrive at a negotiated result if said buyer accepts said non-monetary tradeoff in lieu of said price discount.

31. The method of claim 28, wherein said at least one non-monetary tradeoff comprises one or more of the following: free training; technical support; and/or on-site training.

32. The method of claim 28, further comprising the step of receiving at least one non-monetary tradeoff from the buyer.

33. The method of claim 30, wherein said received non-monetary tradeoff comprises one or more of the following: at least one business referral; a long term commitment; an immediate agreement to purchase the seller's good and/or services.

34. The method of claim 28, further comprising the step of identifying benefits that the buyer will receive by accepting said non-monetary tradeoffs.

35. The method of claim 32, wherein said benefits comprise one ore more of the following: a decrease in risk; an increase in user satisfaction; and/or a decrease in the cost of training.

36. A system for determining the impact of providing the buyer with a price discount on a seller's commission, comprising code for one or more of the following:
calculating the number of additional hours that the seller will be required to work if said discount is provided;
calculating the amount of sales the seller will make if said discount is not provided;
calculating the amount of sales the seller will lose if said discount is provided; and
a report generator for providing a summary report of one or more of the following: said additional hours calculation, said sales made without a discount calculation, and/or said lost sales calculation.
